(19) United States
(12) Patent Application Publication
(10) Pub. No.: US 2025/0239718 A1
(43) Pub. Date: Jul. 24, 2025

(54) Pressure equalization element for containers, preferably for Battery housings for vehicles

(71) Applicant: KACO GmbH + Co. KG, Kirchardt (DE)

(72) Inventors: Bernd Schulz, Ilsfeld (DE); Corina Scheuler, Kirchardt (DE); Peter Wagner, Ludwigsburg (DE); Eugen Lamparter, Gundelsheim (DE)

(73) Assignee: KACO GmbH + Co. KG, Kirchardt (DE)

(21) Appl. No.: 19/033,731

(22) Filed: Jan. 22, 2025

(30) Foreign Application Priority Data
Jan. 24, 2024 (DE) 10 2024 000 289.8

(51) Int. Cl. H01M 50/333; H01M 50/249

(52) U.S. Cl. CPC H01M 50/333; H01M 50/249; H01M 2200/20

(57) ABSTRACT

A pressure equalization element is intended for containers, preferably for vehicle battery housings. It has a housing with at least one inlet and at least one outlet for a gaseous medium, preferably air. It also has a valve element which is located in the flow path of the gaseous medium from the inlet to the outlet. A second valve element is provided in the flow path of the gaseous medium from the inlet to the outlet so that the pressure equalization element with its simple design enables reliable pressure equalization and reliable emergency venting in the event of danger. Both valve elements are pressurized against each other with different forces, whereby the pressure forces are provided in such a way that at least one valve element can be moved into a vacuum relief position and at least the other valve element into an overpressure relief position.

### CROSS-REFERENCE TO RELATED APPLICATION

This application claims the benefit of German Patent Application DE 10 2024 000 289.8, filed on Jan. 24, 2024, the content of which is incorporated by reference in its entirety.

### TECHNICAL FIELD

The disclosure relates to a pressure equalization element for containers, preferably for battery housings of vehicles.

### BACKGROUND

In order to protect the battery of an electric vehicle, which is used at least partially as a traction energy storage device, from environmental influences, a plurality of individual cells of the battery are installed in a housing or container. At least one pressure equalization element is located in the wall of the housing to enable pressure equalization between the ambient pressure and the internal pressure of the container.

Furthermore, the known pressure equalization elements are designed in such a way that they not only equalize the pressure, but also allow emergency venting of the container, which can be used to quickly relieve high pressure inside the container due to a malfunction. However, such pressure equalization elements are complex in design and require a great deal of manufacturing, assembly and testing.

### SUMMARY

The present application presents a pressure equalization element that enables reliable pressure equalization and reliable emergency venting in the event of danger with a simple design.

The pressure equalization element has two valve elements which are located in the flow path of the gaseous medium from the inlet to the outlet and vice versa. Both valve elements are pushed against each other, and in particular spring loaded against each other.

The two valve elements are subjected to different loads in order to enable different functions of the pressure equalization element. The valve elements can be adjusted so that they enable overpressure relief and vacuum relief of the container interior. The container is relieved of an underpressure, or vacuum, when the ambient pressure is higher than the pressure inside the container. The pressure force is set so that the corresponding valve element can be moved when the external pressure is greater than the pressure inside the container. The corresponding valve element is then adjusted so that the interior of the container can be vacuum relieved.

In the overpressure relief position, the interior of the container is relieved of an overpressure if the pressure inside the container is greater than the ambient pressure. In this case, the corresponding valve element is moved against the pressure force so that the gaseous medium can flow from the inside of the container outwards through the outlet into the ambient area.

The two valve elements can be accommodated in a small installation space with regard to the different functions of the pressure equalization element, so that the pressure equalization element can be designed to save space.

Advantageously, the pressure force for the two valve elements is generated by at least one compression spring in each case. This allows the pressure force to be specifically adjusted to the respective valve element so that the vacuum relief or overpressure relief function can be reliably triggered when the specified pressure force values are reached. Optionally, the compression force-generating compression spring can be combined with a magnet, which allows installation space advantages to be achieved. Alternatively, the compression force-generating compression spring can be replaced entirely by a magnet.

The two valve elements are advantageously accommodated in a guide part so that they can be moved safely into the respective position for vacuum relief or overpressure relief.

A particularly simple and compact design is advantageous if the housing is formed by a cover and a support. This design enables simple assembly and manufacture of the pressure equalization element.

The cover of the housing is advantageously provided with the guide part for the two connecting elements.

The pressure compensation element is preferably designed in such a way that the guide part extends through the support. The valve elements can then first be inserted into the guide part during assembly and then the cover with the guide part and the valve elements mounted in it can be inserted through the support.

To ensure that the cover and the support are securely connected to each other, the cover is designed so that it is pulled against the support by a tensile force. The tensile force is so high that the cover cannot lift off the support during normal use of the pressure equalization element. This is only possible if there is an undesirably high increase in pressure inside the container, for example due to a thermal malfunction in connection with degassing of at least one battery cell. The cover is then lifted off the support against the tensile force, so that the excess pressure in the container can be released immediately.

To achieve this compressive force, at least one compression spring is advantageously used, which is supported axially on the side facing away from the cover on the guide part and on the support. The pressure spring is thus used to pull the cover firmly against the support via the guide part. Optionally, the compression spring that generates the compression force can be combined with a magnet, which allows space savings to be achieved. Alternatively, the compression force-generating compression spring can be replaced entirely by a magnet.

To ensure a perfect seal between the support and the cover, the cover lies against the support with at least one seal, preferably a sealing ring, in between. The seal can be provided on the cover and/or on the support. In the installation position, the seal is sufficiently elastically deformed by the tensile force of the compression spring to ensure a perfect seal.

Optionally, a magnet can supplement the compression spring; in particular, the seal can be magnetically effective and combined with the compression spring. Alternatively, the compression spring that generates the compression force can be completely replaced by the magnetically effective seal, which results in advantages in terms of installation space.

A compact and structurally simple design is advantageously achieved if the two valve elements are arranged coaxially to each other. In this case, the two valve elements can be mounted on the pressure equalization element to save space. If the valve elements are accommodated in the guide part of the cover, the valve elements can be fitted very easily by means of a plug-in process.

Advantageously, the compression springs, with which the two valve elements are loaded in opposite directions, are aligned with each other, resulting in a particularly compact design.

This is particularly beneficial if the compression springs are arranged coaxially to each other. The compression springs are then located in the smallest possible space within the pressure compensation element.

It is advantageous here that the pressure spring for the cover surrounds the pressure springs for the two valve elements at a distance. This results in a nested design, which contributes to the compact and structurally simple design of the pressure compensation element.

In the overpressure relief position, the two valve elements are at such an axial distance from each other that a passage is created for the gaseous medium from inside the container to the environment. The corresponding valve element is displaced against the pressure force acting on it.

In the vacuum relief position, the corresponding other valve element, which is proximal to the container, is moved against a stop against the pressure force acting on it. An access is then created so that the gaseous medium can enter the container from the environment.

In a further design simplification, the two valve elements are formed by a one-piece double piston. It is loaded on both sides by a respective compression spring. The compression springs are designed in such a way that the double piston first assumes an initial position from which it can be displaced accordingly for vacuum relief or overpressure relief of the container. During this displacement process, the spring loading it in the displacement direction is compressed under the pressure of the gaseous medium.

For emergency venting, the support is provided with at least one passage through which the pressure of the gaseous medium in the container acts directly on the cover of the housing.

If a predetermined pressure is exceeded in the container, the cover is lifted off the support against the force of the compression spring that loads it. This releases an outlet which is determined by the distance between the support and the cover. This outlet has a large opening cross-section so that the excess pressure in the container can be released quickly.

The following detailed description is merely exemplary in nature and is not intended to limit the invention or the application and uses of the invention. Furthermore, there is no intention to be bound by any theory presented in the preceding background or the following detailed description.

### BRIEF DESCRIPTION OF THE DRAWINGS

The invention is explained in more detail with reference to two embodiments shown in the drawings.

FIG. 1 shows a perspective view of a first embodiment of a pressure equalizing element in an initial position.

FIG. 2 shows a half section through the pressure equalization element according to FIG. 1.

FIG. 3 shows an axial section through the pressure equalization element as shown in FIG. 1.

FIG. 4 to FIG. 6 show the pressure equalization element in a vacuum relief position as shown in FIGS. 1 to 3.

FIG. 7 to FIG. 9 show the pressure equalization element in an overpressure relief position as shown in FIGS. 1 to 3.

FIG. 10 to FIG. 12 show the pressure equalization element in an emergency venting position as shown in FIGS. 1 to 3.

FIG. 13 to FIG. 15 show a second embodiment of a pressure equalizing element in an initial position, comparable to what is shown in FIGS. 1 to 3.

FIG. 16 to FIG. 18 show, in representations corresponding to FIGS. 1 to 3, the pressure equalization element according to FIGS. 12 to 15 in a vacuum relief position.

FIG. 19 to FIG. 21 show, in representations corresponding to FIGS. 13 to 15, the pressure equalization element in an overpressure relief position.

FIG. 22 to FIG. 24 show the pressure equalization element in an emergency venting position as shown in FIGS. 13 to 15.

### DETAILED DESCRIPTION

The pressure equalization element is used in containers, such as battery housings, and serves to equalize the pressure between the inside of the container and the environment.

The vast majority of batteries for electric drives in motor vehicles, and therefore also the battery housings, are nowadays installed in the underfloor area of the passenger compartment. The battery housing accommodates a number of interconnected battery cells which are arranged in one layer or plane.

The pressure equalization elements described below, in particular for a battery housing as described above, fulfil four functions.

In an initial position, there is no equalization between the inside of the container and the surroundings.

In a vacuum relief position, pressure equalization between the inside of the container and the environment is ensured.

In an overpressure relief position, an overpressure in the container can be released.

Finally, in an emergency venting position, the pressure equalization element enables a rapid reduction of excessive pressure occurring in the container, accompanied by strong gas formation and high temperatures at certain points, and to perform directed and timely venting and prevent the battery from exploding.

The pressure compensation element therefore fulfills all four functions as a single unit. The pressure compensation element is simple in design, yet inexpensive to manufacture and reliable in terms of its various functions.

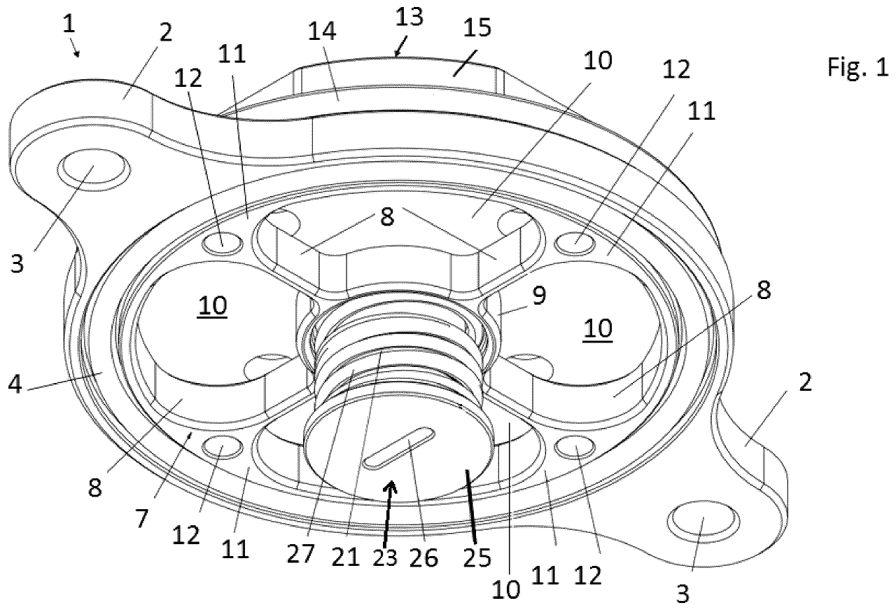

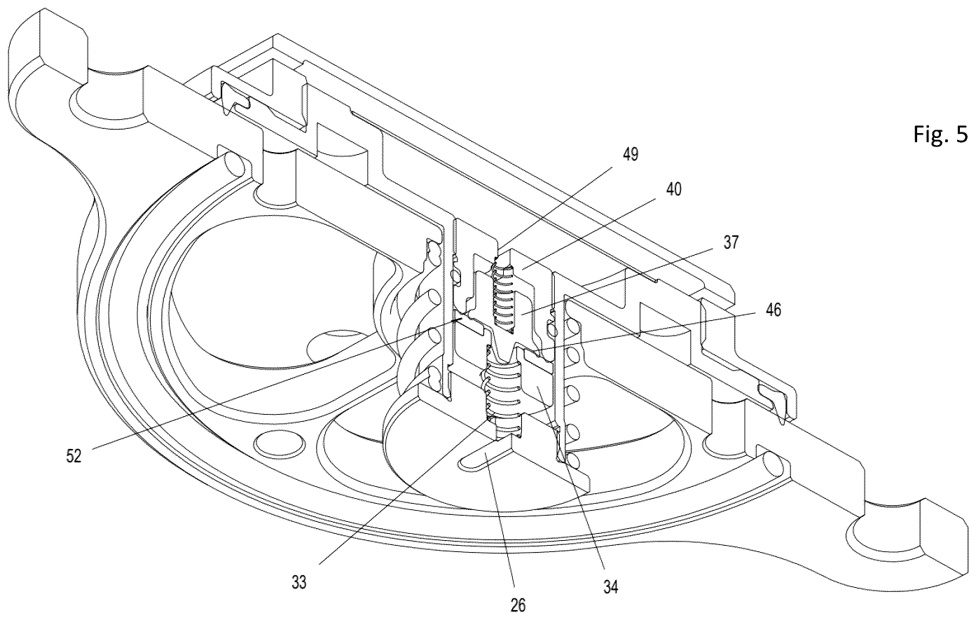

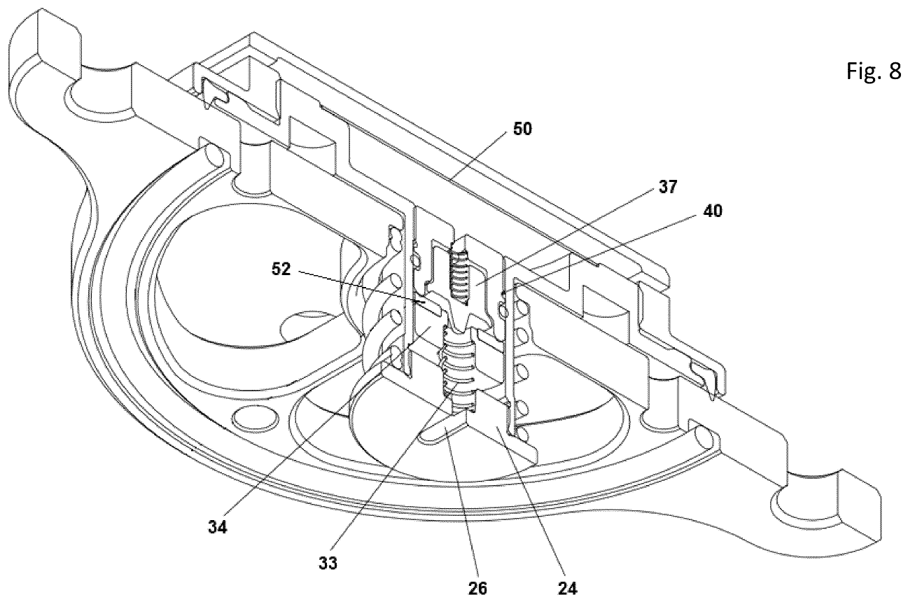

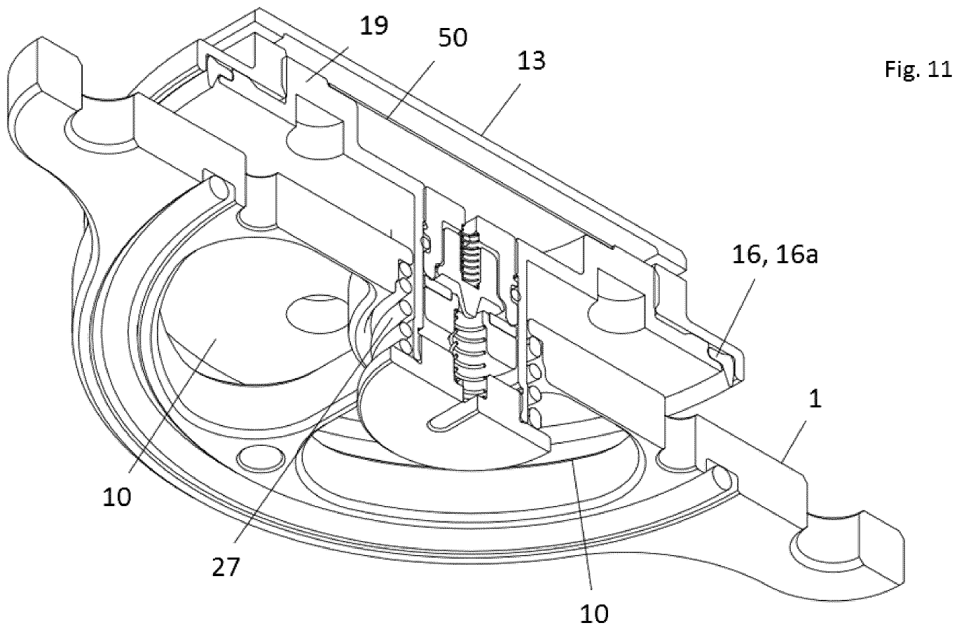

The pressure equalization element shown in FIGS. 1 to 12 is designed to seal axially.

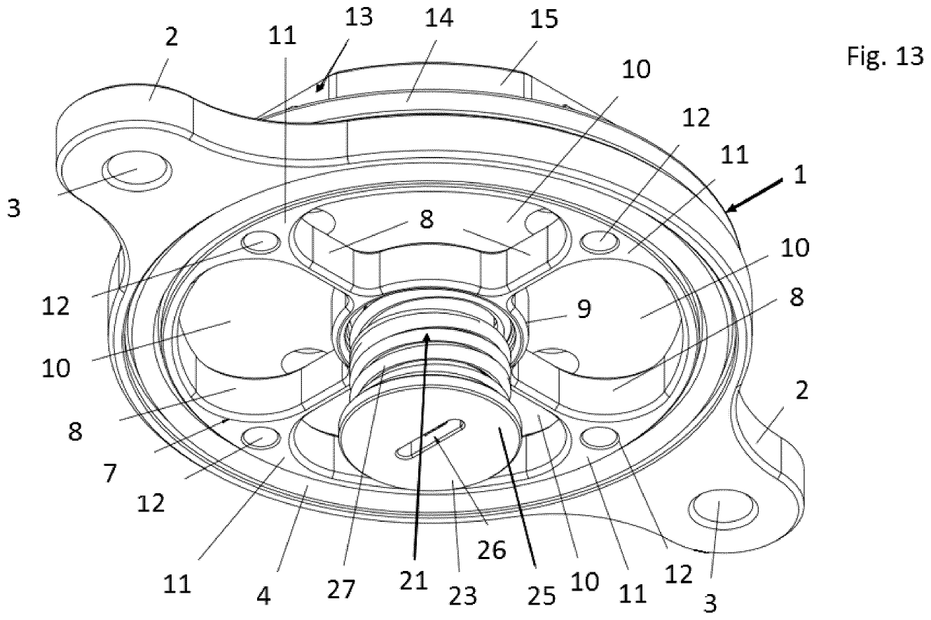

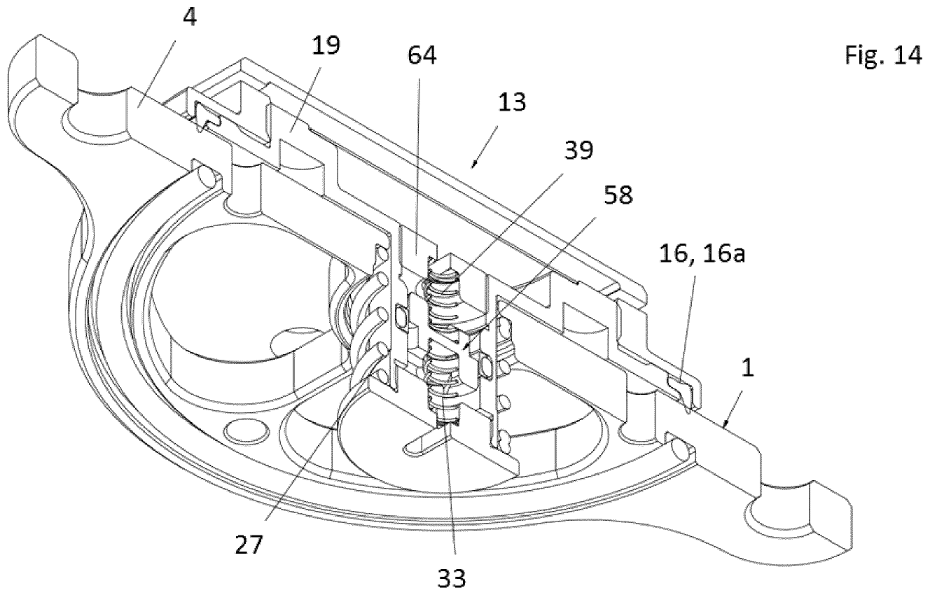

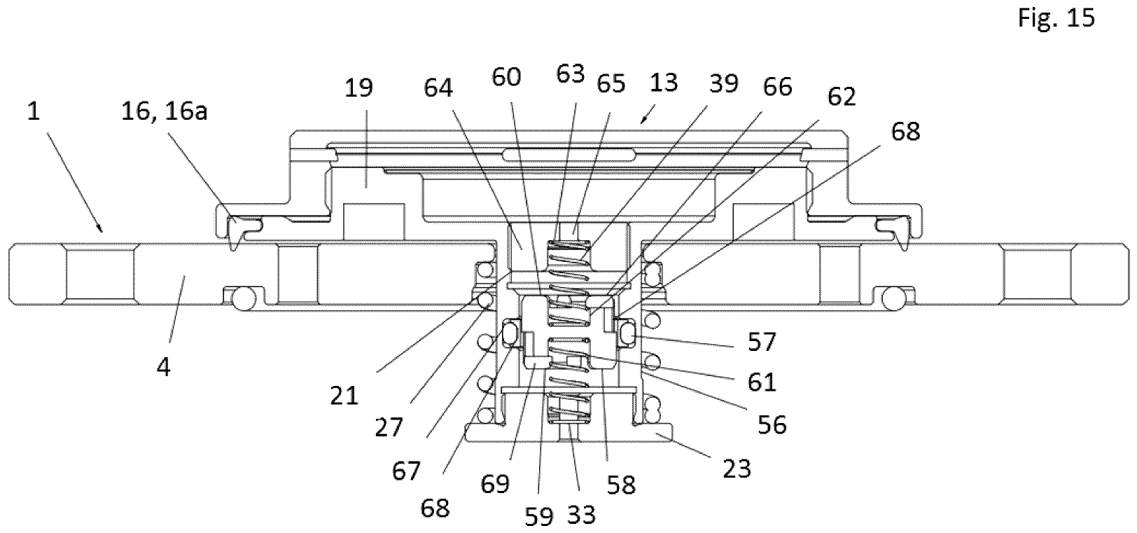

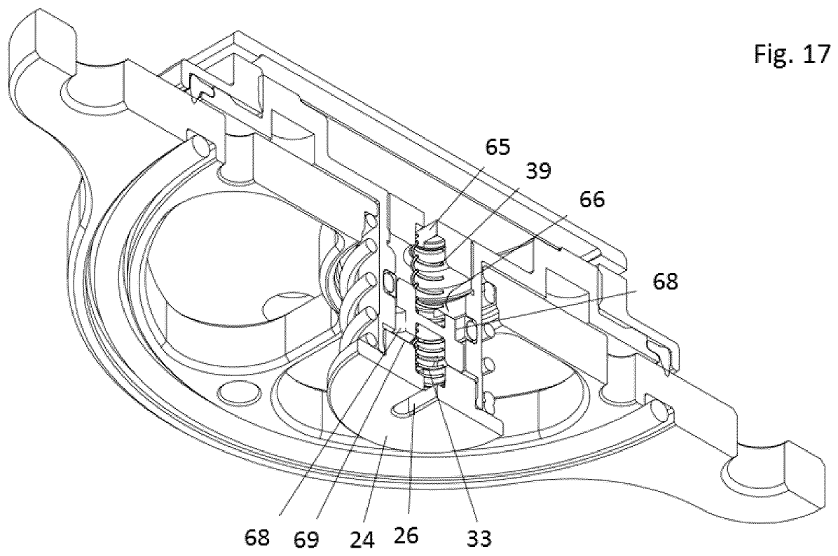

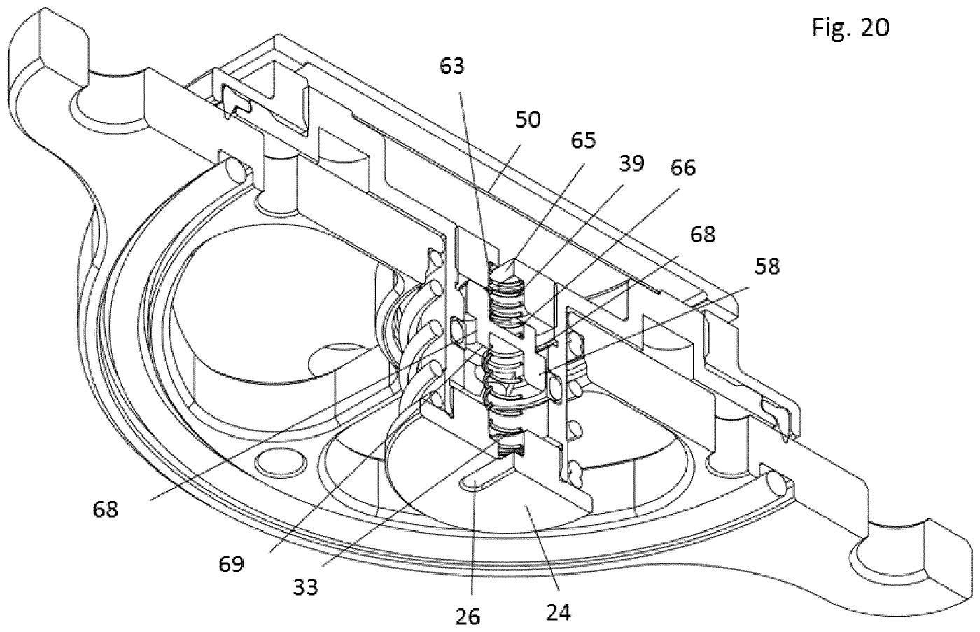

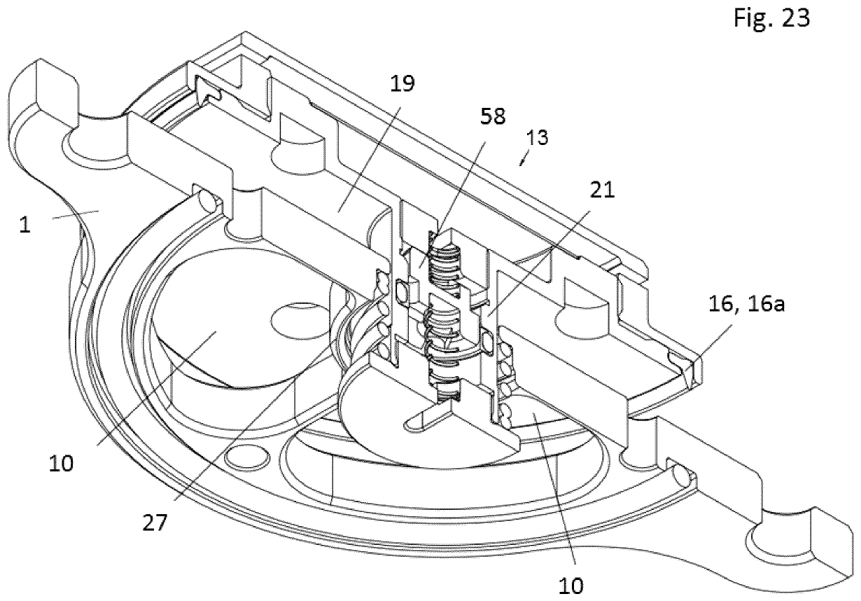

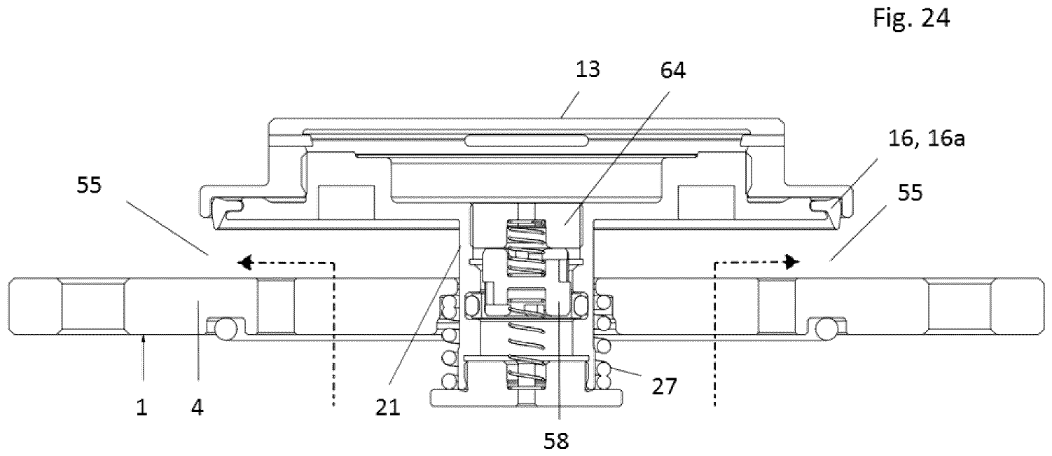

In the pressure compensation element shown in FIGS. 13 to 24, the sealing is radial.

The pressure equalization element is installed in a container (not shown) of a battery of an electric vehicle. Several modules are accommodated in the container in a known manner, whereby each battery module can consist of several battery cells. The battery container is advantageously made of metal and has at least one installation opening into which the pressure equalization element is inserted. It sits sealed in this installation opening and can ensure pressure equalization between the pressure inside the container and the environment.

In addition to the battery modules mentioned, the container also has other components that are known per se and include, for example, components for managing the battery modules.

The container can have any suitable design. Depending on the size of the container, it may have more than one pressure equalization element. The installation opening of the battery container can be provided on any suitable side of the housing.

The pressure equalization element has a disc-shaped support 1 with outwardly protruding eyes 2, each of which is provided with a passage opening 3. The eyes 2 are arranged diametrically opposite each other, for example, and are used to attach the pressure equalization element to the battery container. Screws are inserted through the apertures 3, with which the support 1 is fastened against the outside of one of the walls of the battery container.

The support 1 has an annular base body 4, which has an annular groove 5 on its underside facing the battery container, which accommodates an annular seal 6, which is advantageously formed by an elastic molded ring, in particular an O-ring.

It is used to seal the pressure equalization element against the housing wall to which the pressure equalization element is attached.

Inside the base body 4 is a strut 7, which has, for example, four arms 8 that are approximately at right angles to each other and whose radially inner ends connect to a ring 9.

Together with the ring 9 and the ring-shaped base body 4, the arms 8 define openings 10, which are distributed around the circumference of the base body 4. The arms 8 are arranged on edge so that their longitudinal sides extend in the axial direction of the pressure equalization element.

In the transition area 11 from the arms 8 to the ring-shaped base body 4, there are further openings 12, which pass through the transition area 11 and have a circular cross-section. The openings 12 are considerably smaller than the openings 10.

The support 1 with the base body 4 and the strut 7 with the arms 8 and the ring 9 is advantageously designed as a single piece. The support 1 can be made of a metallic material, but also of a correspondingly hard plastic. Preferably, conventional manufacturing processes are used to produce the individual components, such as 2K injection molding, direct injection molding of metal and plastic using deep-drawn parts or continuous casting profiles.

The pressure equalization element has a cover 13 which, in the initial position of the pressure equalization element, rests in a sealed manner on the base body 4 of the support 1. The cover 13 has an annular flange 14, which projects radially outwards from a cylindrical casing 15. The free edge of the annular flange 14 is angled in the direction of the base body 4 of the support 1 and serves as a radial boundary for a sealing ring 16, which in the initial position rests on the base body 4 with a sealing lip 16a in a sealing manner. In this sealing position, the angled edge of the ring flange 14 is at a distance from the base body 4, so that a reliable seal is achieved between the cover 13 and the support 1. The cover 13 and the support 1 form a housing for the pressure equalization element.

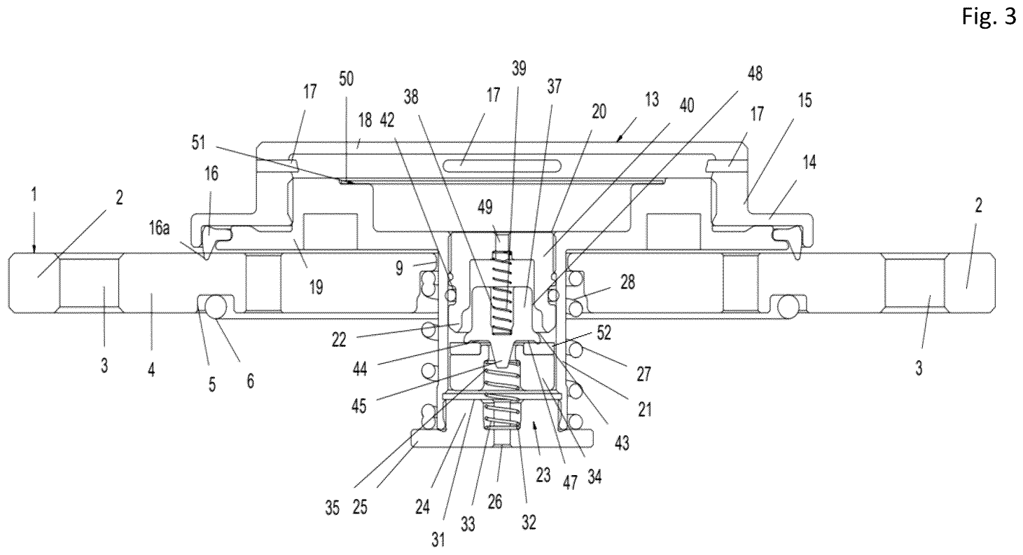

The casing 15 is provided with outlet openings 17, which are advantageously evenly distributed around the circumference of the casing 15. The outlet openings 17 have an exemplary rectangular outline (see also FIG. 3) and extend in the circumferential direction of the casing 15.

The outlet openings 17 are located only a short distance below a disk-shaped end part 18, the outer edge of which is advantageously aligned with the outer edge of the casing 15.

The cover 13 with the ring flange 14, the casing 15 and the end part 18 is advantageously designed as a single piece. The cover 13 can be made of the same material as the support 1.

The sealing ring 16 is attached to the outer edge of a retaining part 19, the outer edge of which extends below the ring flange 14 and to which the sealing ring 16 is attached. The retaining part 19 extends over the circumference of the casing 15 or the ring flange 14 and has a central opening 20, from the edge of which a cylindrical guide part 21 extending in the direction of the base body 4 protrudes. It projects through the ring 9 of the support 1. The guide part 21 is advantageously formed in one piece with the retaining part 19.

The lower end of the cylindrical guide part 21 in FIGS. 1 to 3 is closed by a closure element 23. It projects with a closure part 24 into the guide part 21 and is fastened in a suitable manner to the inner wall of the guide part 21. With an annular flange 25 extending radially outwards, the closure element 23 lies sealingly against the free end face of the guide part 21. The closure part 24 has at least one opening 26 passing through it, which is elongated in the embodiment example and lies in an axial plane of the closure part 24.

The guide part 21 is surrounded by at least one compression spring 27, which is advantageously a helical compression spring. It is supported with one end on the ring flange 25 of the closure element 23 and projects with its other end into an annular groove 28, which is provided in the ring 9 of the support 1. The annular groove 28 is open in the direction of the annular flange 25 of the closure element 23. The compression spring 27 is axially supported on a base 30 of the annular groove 28.

In the installation position, the compression spring 27 generates a tensile force on the cover 13 via the locking part 24 and the guide part 21, the sealing ring 16 of which rests against the ring-shaped base body 4 under this compressive force with elastic deformation. With the compression spring 27, this axial force, with which the cover 13 rests on the support 1, can be continuously adjusted to the intended use of the pressure compensation element.

For example, the axial force corresponds to an equivalent of the internal pressure between 40 mbar and 500 mbar.

The closure part 24 is provided with a central recess 32 on its end face 31 facing the cover 13, into the bottom of which the opening 26 opens. Together with the recess 32, it forms a passage that passes axially through the closure element 23. A further compression spring 33, which is advantageously designed as a helical compression spring, engages in the recess 32. It is supported on the base of the recess 32 and acts axially on a overpressure relief piston 34 forming a valve element, which is arranged in the guide part 21 and is axially displaceable relative to the guide part 21. The overpressure relief piston 34 is guided inside the guide part 21 through its wall.

The overpressure relief piston 34 has a central opening 35 which passes through it axially and which has an annular shoulder 36 on its inner wall, on which the end of the compression spring 33 facing the cover 13 is axially supported.

On the side facing the cover 13, a vacuum relief piston 37 forming a valve element is in contact with the overpressure relief piston 34 under spring force.

On its side facing the cover 13, it is provided with a central recess 38 in which at least one compression spring 39, preferably a helical compression spring, engages. It loads the vacuum relief piston 37 in the direction of the overpressure relief piston 34.

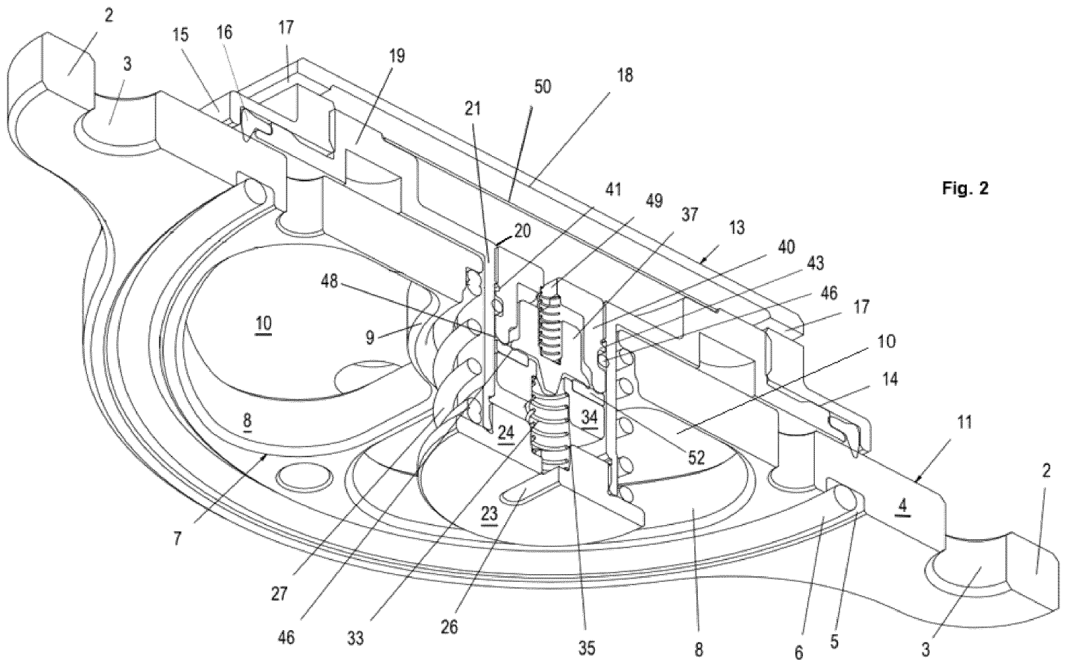

The vacuum relief piston 37 is guided in a guide sleeve 40, which projects axially from the holding part 19 and projects into the guide part 21. The guide sleeve 40 is provided on its outer side with a circumferential annular groove 41, in which a sealing ring 42, preferably an O-ring, is located, with which the cylindrical guide sleeve 40 rests against the inner wall of the guide part 21 in a sealed manner. At its end facing the overpressure relief piston 34, the guide sleeve 40 is provided with an internal extension 43 (see also FIG. 2). In the area of this extension 43, the guide sleeve 40 rests against the inner wall of the guide part 21.

The vacuum relief piston 37 has a conical projection 45 on its piston surface 44, which tapers in the direction of the overpressure relief piston 34 and projects into the opening 35 passing axially through the overpressure relief piston 34. In each position of the vacuum relief piston 37, an annular gap is formed relative to the overpressure relief piston 34 between the conical projection 45 and the wall of the through-opening 35, through which an outflow of a gaseous medium is possible in a manner yet to be described. The further the vacuum relief piston 37 is displaced from the initial position shown in FIGS. 1 to 3 relative to the overpressure relief piston 34, the larger the annular gap between the projection 45 and the wall of the opening 35.

The vacuum relief piston 37 has a sealing ring 46 on the circumference of its piston surface 44, which projects axially beyond the piston surface 44 and which, in the initial position, under the force of the compression spring 39, seals against a sealing washer 52, which is attached to the end face of the overpressure relief piston 34. The sealing disk 52 is designed so that its outer side is flush with the end face of the overpressure relief piston 34. The sealing ring 46 is designed in such a way that the piston surface 44 has a small distance from the end face of the overpressure relief piston 34 when the sealing ring 46 is in contact with the sealing disk 52.

The compression springs 27, 33, 39 are arranged coaxially to each other, with the two compression springs 33, 39 lying coaxially on top of each other. The pressure springs are set so that the pressure equalization element can be used for vacuum relief, overpressure relief, and emergency venting. The pressure springs 27, 33, 39 allow the pressure compensation element to be optimally adjusted to the intended application.

The compression springs 33, 39 are surrounded by the compression spring 27 at a distance and are advantageously arranged largely within this compression spring 27. This nested design, which is particularly evident in FIG. 3, results in a compact design of the pressure compensation element without impairing its functionality.

In the initial position shown in FIGS. 1 to 3, the cover 13 is pulled against the support 1 by the compression spring 27, so that the sealing ring 16 rests on the base body 4 of the support 1 with elastic deformation.

The overpressure relief piston 34 and the vacuum relief piston 37 are axially loaded against each other by the compression springs 33 and 39 so that they lie against each other. The sealing ring 46 rests on the sealing disk 52 of the overpressure relief piston 34, with the projection 45 plunging into the opening 35 of the overpressure relief piston 34. The free end of the guide sleeve 40 is designed as a sealing ring 22, which in the initial position as shown in FIGS. 1 to 3 rests sealingly against the sealing disk 52. The sealing ring 22 and the sealing ring 46 of the vacuum relief piston 37 are each advantageously provided with a circumferential sealing edge 22a, 46a, which enables a high contact pressure. In the initial position, both sealing rings 22, 46 or the circumferential sealing edges 22a, 46a are in contact with the sealing disk 52 and each form an axial seal. The sealing disk 52 is advantageously a soft seal, which is preferably made of thermoplastic elastomer or another flexible plastic material.

In the initial position, no overpressure relief or vacuum relief is possible in a predetermined pressure range, for example in a pressure range between −120 mbar and 80 mbar, in particular between −40 mbar and 15 mbar.

In the area below the end part 18, an air-permeable membrane 50 is located on the retaining part 19, which is provided in the flow path from the inside of the container in front of the outlet openings 17. The air-permeable membrane 50 enables pressure equalization during vacuum relief and overpressure relief. The membrane 50 is attached along its edge to a support surface 51 of the retaining part 19, for example glued or welded on, and lies at a distance above the guide sleeve 40. At the same time, the membrane 50 prevents the entry of water up to a defined water column. The airflow rate and the water column can be adjusted via the type and/or design of the membrane 50. In addition, the desired volume flow of the gaseous medium or the air can be set separately for both the vacuum relief and overpressure relief via the geometry of the valve elements or the overpressure relief piston 34 and/or the vacuum relief piston 37.

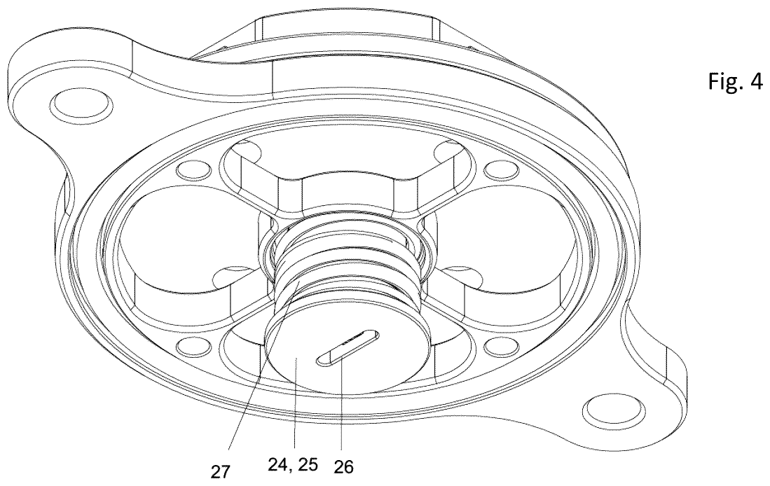

FIGS. 4 to 6 show the pressure equalization element in the vacuum relief position. The pressure outside the container is greater than the pressure inside the container. The force acting on the overpressure relief piston 34 and the vacuum relief piston 37 is greater than the force of the compression spring 33. The gaseous ambient medium acts via the outlet openings 17 and the opening 49 of the guide sleeve 40 on the vacuum relief piston 37, which displaces the overpressure relief piston 34 against the force of the compression spring 32 until it comes into contact with an axial stop 53. The axial stop 53 is, for example, a circlip inserted into the inner wall of the guide part 21. The axial stop 53 can also be provided by other suitable design measures on the guide part 21.

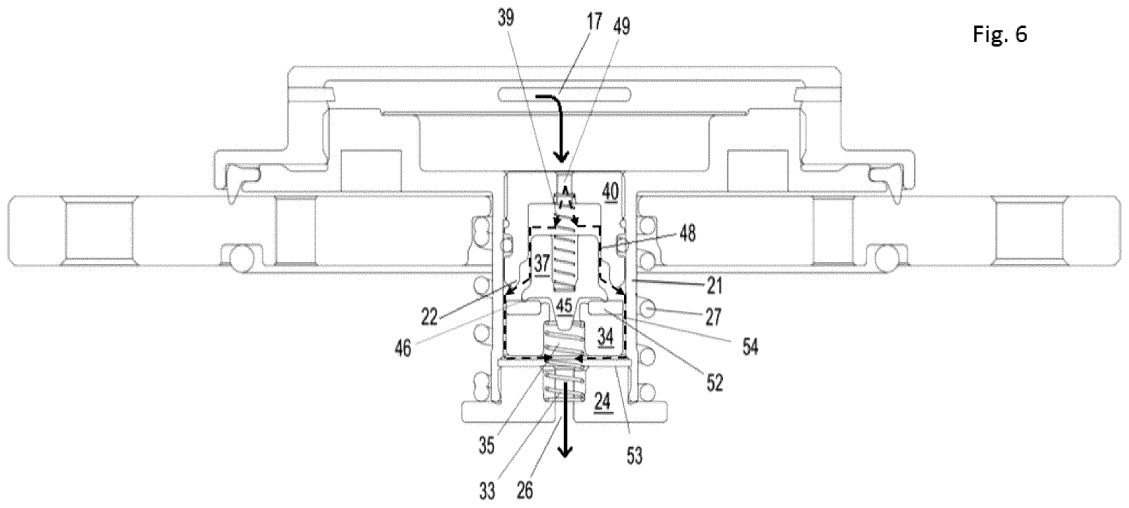

The vacuum relief piston 37 is displaced axially within the guide sleeve 40 to such an extent that the sealing ring 46 of the vacuum relief piston 37 is located outside the guide sleeve 40 and continues to make sealing contact with the sealing disk 52. The sealing ring 22 of the guide sleeve 40 is at a distance from the sealing disc 52. The ambient medium flows through the outlet openings 17 and the membrane 50 into the annular gap 48 between the guide sleeve 40 and the vacuum relief piston 37 and enters an annular space 54 between the guide part 21 and the overpressure relief piston 34. From here, the ambient medium can flow below the overpressure relief piston 34 into the opening 26 of the closure part 24 into the interior of the container. The flow path described is indicated by the flow arrows in FIG. 6. As already mentioned, the desired volume flow of the gaseous medium or the air can be set separately for both the vacuum relief and the overpressure relief function via the geometry of the valve elements or the overpressure relief piston 34 and/or the vacuum relief piston 37.

As the overpressure relief piston 34 is displaced, the sealing disk 52 of the overpressure relief piston 34 lifts off the sealing ring 46 of the guide sleeve 40, so that the axial sealing point between the sealing ring 46 and the sealing disk 52 is opened, allowing the air from the environment to flow into the container in the manner described.

As soon as the pressure force exerted by the air on the vacuum relief piston 37 is less than the spring force exerted by the compression spring 33, both pistons 34 and 37 are moved back to the initial position shown in FIGS. 1 to 3. The sealing ring 22 of the guide part 21 is then once again in sealing contact with the sealing disk 52 of the overpressure relief piston 34.

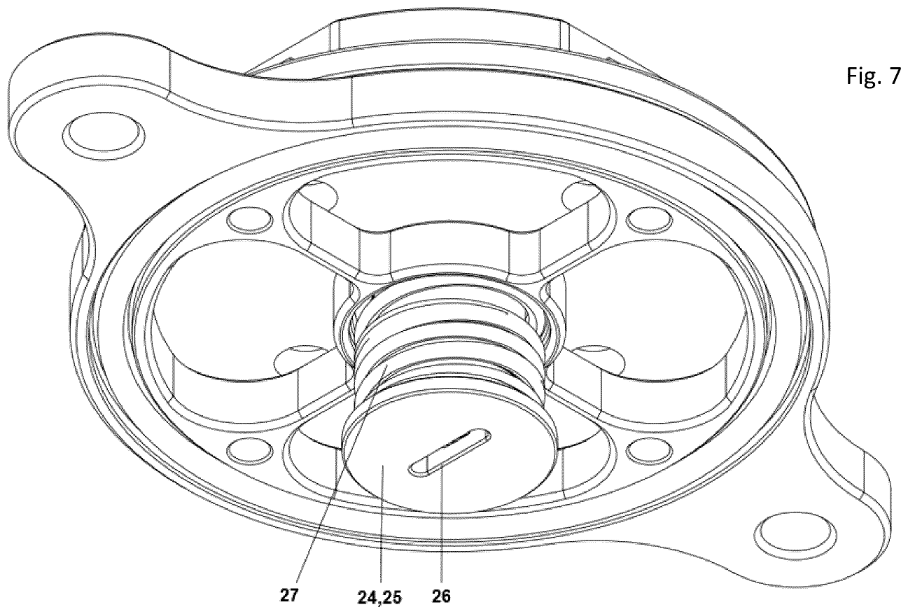

FIGS. 7 to 9 describe the overpressure relief position of the pressure equalization element. This overpressure relief position is reached when the pressure inside the container is greater than the pressure outside. This increased pressure acts on the piston surface 44 of the vacuum relief piston 37 via the opening 26 of the closure part 24 and the opening 35 of the overpressure relief piston 34. As a result, the vacuum relief piston 37 is displaced into the guide part 40 against the force of the compression spring 39. The sealing ring 46 of the vacuum relief piston 37 lifts off the sealing disk 52 of the overpressure relief piston 34, so that the axial sealing point between the overpressure relief piston 34 and the vacuum relief piston 37 is opened. As a result, the gaseous medium can flow from the inside of the container via the open sealing point and the annular gap 48 between the vacuum relief piston 37 and the guide sleeve 40 to the opening 39 and from there through the membrane 50 to the outlet openings 17, via which the gaseous medium leaves the pressure equalization element.

The axial sealing point between the guide sleeve 40 and the sealing disk 52 of the overpressure relief piston 34 is maintained.

As soon as the pressure in the container is lower than the pressure force exerted by the compression spring 39, the vacuum relief piston 37 is pushed back until the sealing ring 46 makes sealing contact with the sealing disk 52.

The compression spring 33 axially loading the overpressure relief piston 34 is set so that it is greater than the force exerted by the compression spring 39 on the vacuum relief piston 37. As a result, the overpressure relief piston 34 remains in contact with the guide sleeve 40 in the described overpressure relief position.

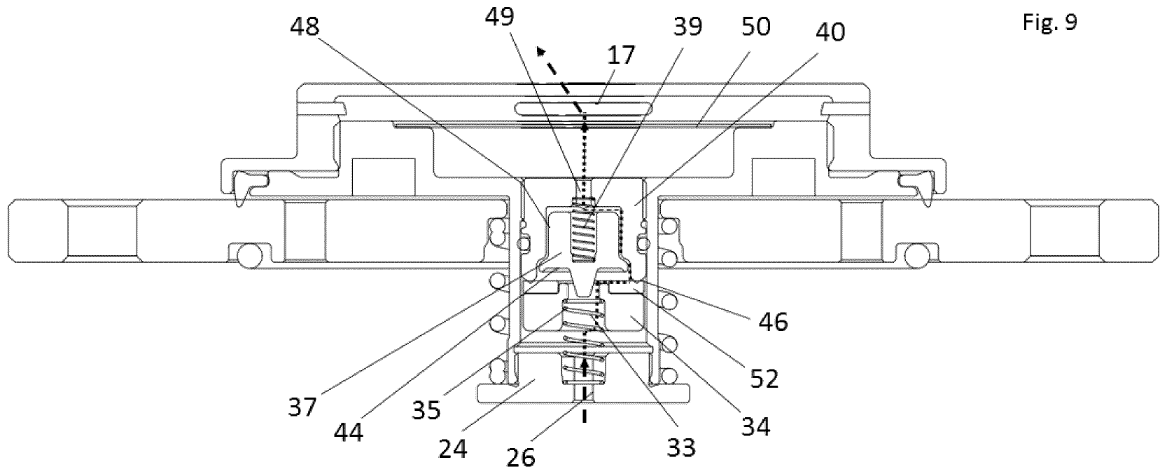

In FIG. 9 the flow arrows illustrate the flow pattern.

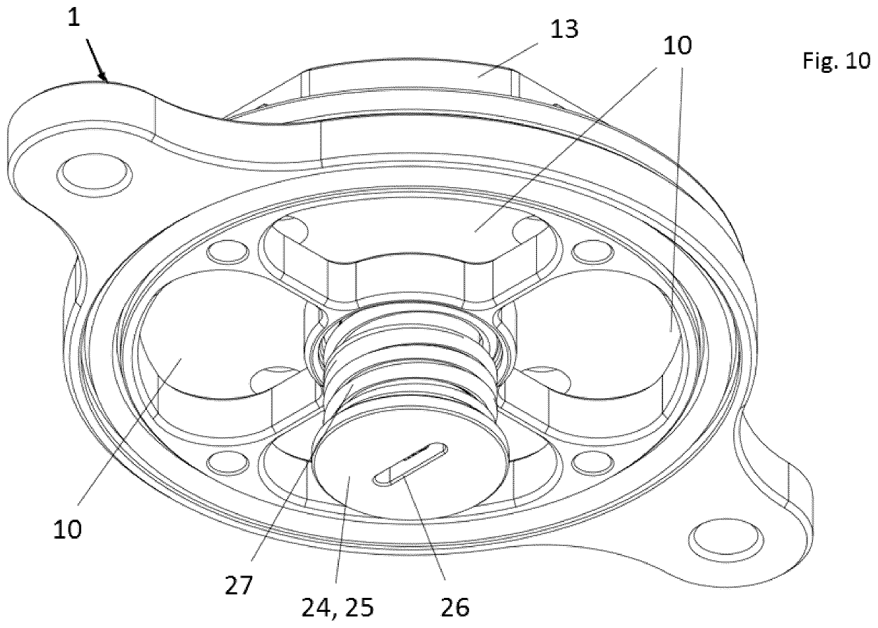

FIGS. 10 to 12 shows the case of emergency venting.

It is required if the pressure in the container becomes so high that there is a risk of damage to the container. In this case, the emergency venting position of the pressure equalization element ensures that this high pressure can be reduced immediately and that any hot mass flow of the gaseous medium does not build up in the container. For this purpose, the cover 13 is lifted off the support 1 together with the membrane 50. The pressure force of the gaseous medium in the container is greater than the force of the compression spring 27, with which the cover 13 is pulled against the support 1.

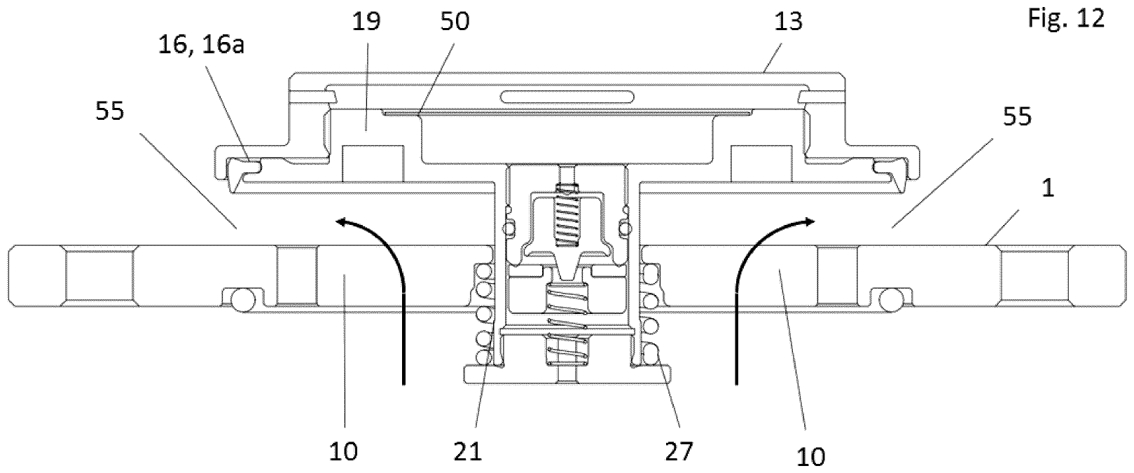

The gaseous medium in the container acts directly on the cover 13 or its holding part 19 via the openings 10 of the support 1, whereby the cover 13 is lifted off the support 1. The sealing ring 16 of the cover 13 thus provides a large opening cross-section 55 (see also FIG. 12), so that the gaseous medium can pass directly into the environment outside the container, bypassing the pistons 34, 37. The opening cross-section 55 advantageously corresponds approximately to the entire opening cross-section in the housing, with the opening being provided to accommodate the pressure equalization element. Preferably, the opening cross-section 55 comprises a flow-through annular area of approximately 500 mm² to 5000 mm². The corresponding flow arrows are shown in FIG. 12.

As soon as the high pressure in the container is released, the cover 13 is returned by the compression spring 27 to its initial position as shown in FIGS. 1 to 3, in which the sealing ring 16 is in sealing contact with the base body 4 of the support 1 in the manner described. The guide part 21 of the support 13 is moved together with the pistons 34, 37.

The compression springs 27, 33, 39 are matched to one another in such a way that the individual parts of the pressure equalization element are adjusted relative to one another in the manner described in order to achieve the vacuum relief, overpressure relief, and emergency position.

The embodiment shown in FIGS. 13 to 24 is essentially the same as the embodiment shown in FIGS. 1 to 12. The pressure equalization element can also assume an initial position, a vacuum relief position, an overpressure relief position, and an emergency venting position.

The support 1 has the same design as in the previous embodiment, so that reference can be made to the description there. The support 1 has the ring-shaped base body 4, on which the sealing ring 16 with a sealing lip 16a rests in a sealing manner under elastic deformation in the initial position.

The cylindrical guide part 21 of the holding part 19 has an annular groove 56 on its inner wall, in which a sealing ring 57 is housed. It forms a radial seal that seals a double piston 58 against the guide part 21. The double piston 58 can be regarded as two valve elements that are formed in one piece with each other.

The double piston 58 is slideably mounted in the guide part 21 as a valve element, which has a central recess 61, 62 on each of its two opposing piston surfaces 59, 60, in which the compression springs 33, 39 engage. The compression spring 33 is axially supported on the closure element 23 in accordance with the previous embodiment. The opposite compression spring 39 engages in a recess 63 of a support part 64, which is a component of the retaining part 19 of the cover 13. The compression spring 39 is axially supported on the support part 64.

As in the previous embodiment, the two compression springs 33, 39 are axially aligned with each other and coaxial with the compression spring 27, with which the cover 13 is pressed or pulled against the support 1 in the manner described.

A central opening 65 opens into the recess 63 of the support part 64, through which the gaseous medium can pass from the container to the surroundings or from the surroundings into the container.

As already mentioned, the desired volume flow of the gaseous medium or air can also be set separately for both the vacuum relief and overpressure relief functions via the geometry of the valve elements or the double piston 58.

FIGS. 13 to 15 shows the pressure equalization element in the initial position, in which the double piston 58 is arranged inside the guide part 21 in such a way that the sealing ring 57 blocks the passage of air to the outlet openings 17 of the cover 13. As in the first embodiment, no vacuum relief and overpressure relief is provided in a certain pressure range. This pressure range is, for example, between −120 mbar and +80 mbar, in particular between approximately −40 mbar and approximately +15 mbar.

In the initial position shown in FIGS. 13 to 15, the double piston 58 is held in an initial position by the two compression springs 33, 39, in which the sealing ring 57 seals the double piston 58 against the guide part 21.

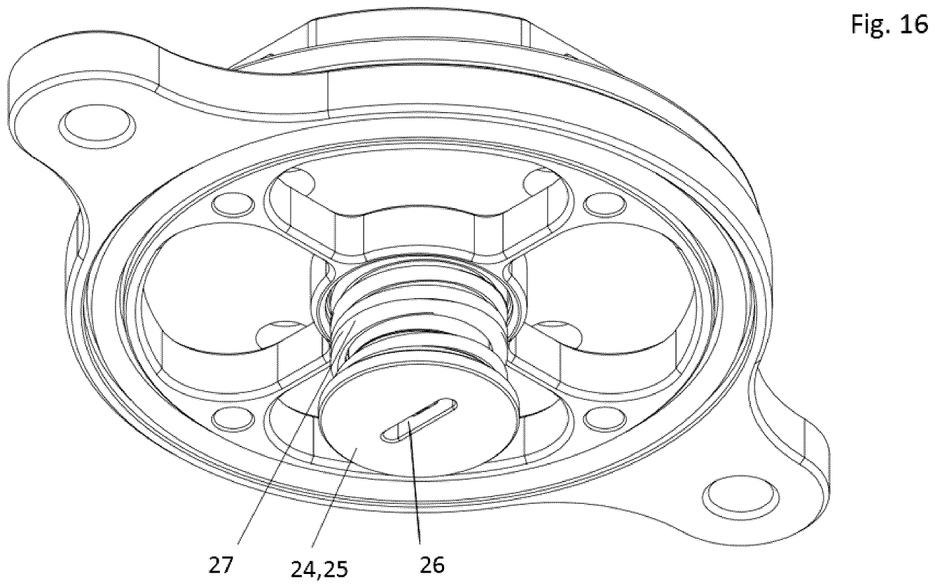

FIGS. 16 to 18 shows the pressure equalization element in the vacuum relief position. In this case, the pressure outside the container is higher than the pressure inside the container. The force of the compression spring 33 is set so that in this case it is smaller than the pressure force acting on the piston surface 60. The ambient air flows through the outlet openings 17 of the cover 13 and through the membrane 50 into the opening 65 of the support part 64 to the double piston 58. It is displaced axially within the guide part 21 until it comes into contact with the end face of the closure part 24.

The double piston 58 is provided with a flow groove 66 on its piston surface 60, which is flow-connected to a flow groove 68 provided in the outer surface 67 of the double piston 58. As an example, the flow groove 66 is designed here as an annular groove.

A further flow groove 69 is provided on the opposite piston surface 59 of the double piston 58, into which the flow groove 68 located in the outer surface 67 opens. The other flow grooves 68, 69, which are clearly visible here, are also designed as annular grooves.

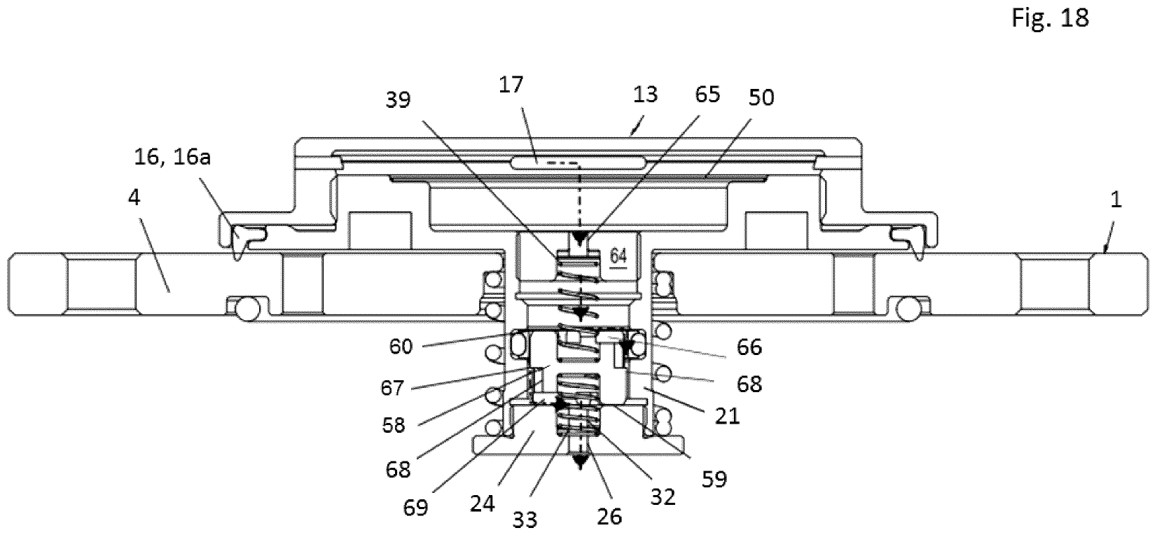

As the flow arrows in FIG. 18 shows, in the vacuum relief position the outside air can enter the pressure equalization element through the outlet openings 17 and then flow axially through the support part 64 to the double piston 58. The air passes through the annular grooves 66 to 68 into the central recess 32 and from there through the opening 26 of the closure part 24 into the interior of the container. As soon as the pressure decreases, the double piston 58 is pushed back into the initial position as shown in FIGS. 13 to 15 by the compression spring 33.

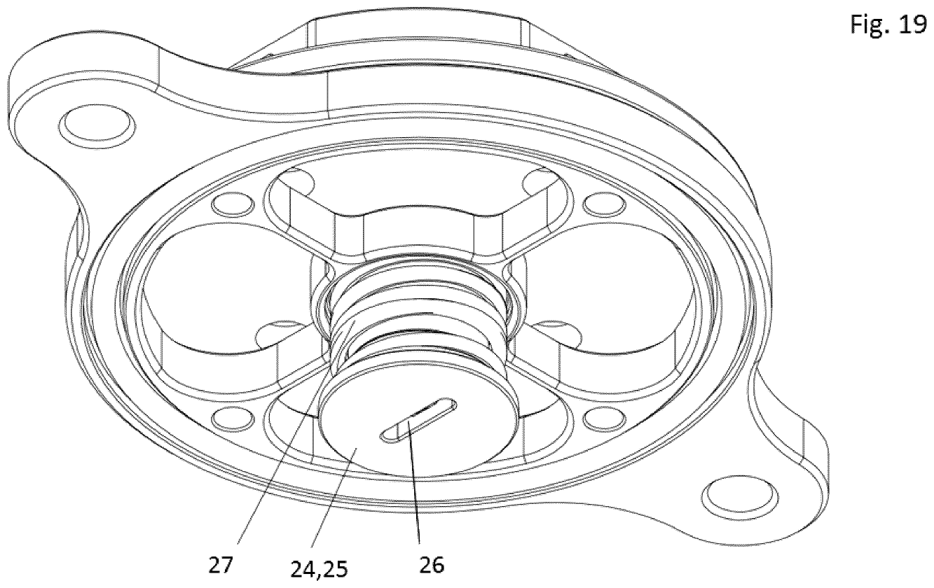

FIGS. 19 to 21 shows the overpressure relief position of the pressure compensation element. The overpressure relief position is reached when the pressure inside the container is greater than the pressure outside. The pressure spring 39 is set so that at a predetermined internal pressure, the pressure force acting on the double piston 58 is greater than the force of the pressure spring 39. As a result, the double piston 58 is displaced axially in the guide part 21 against the force of the pressure spring 39 until the double piston 58 comes into contact with the end face of the support part 64.

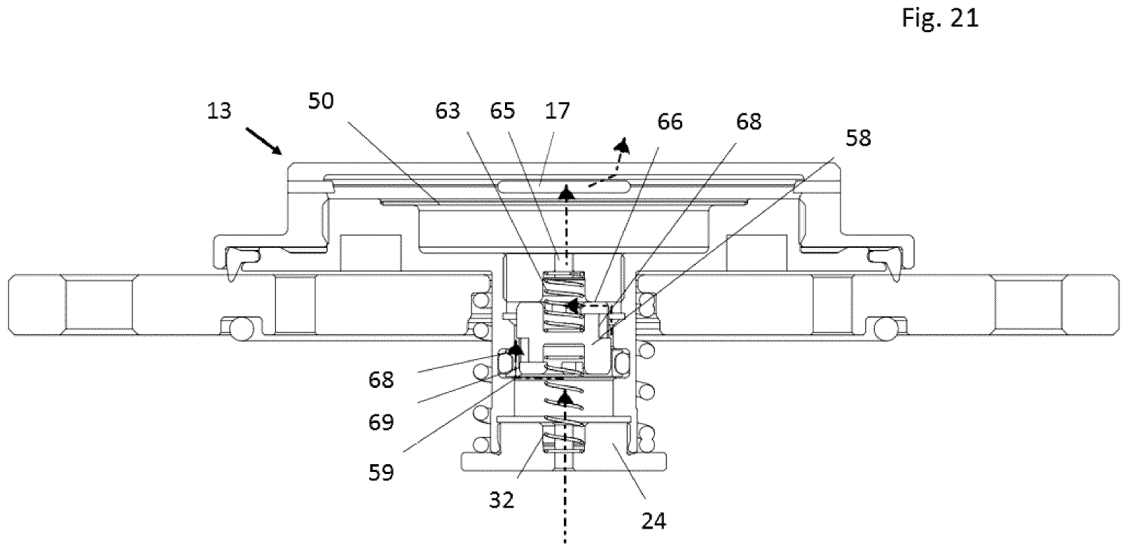

The gaseous medium inside the container passes through the opening 26 and the recess 32 in the closure part 24 to the piston surface 59 of the double piston 58. The air can flow into the recess 63 and through the opening 65 of the support part 64 via the flow grooves 66, 68 and 69. The air then passes via the air-permeable membrane 50 through the outlet openings 17 of the cover 13 into the environment outside the container. The flow path is indicated in FIG. 21 by the corresponding flow arrows.

As soon as the pressure in the tank has been reduced, the pressure spring 39 pushes the double piston 58 back into the initial position, as shown in FIGS. 13 to 15.

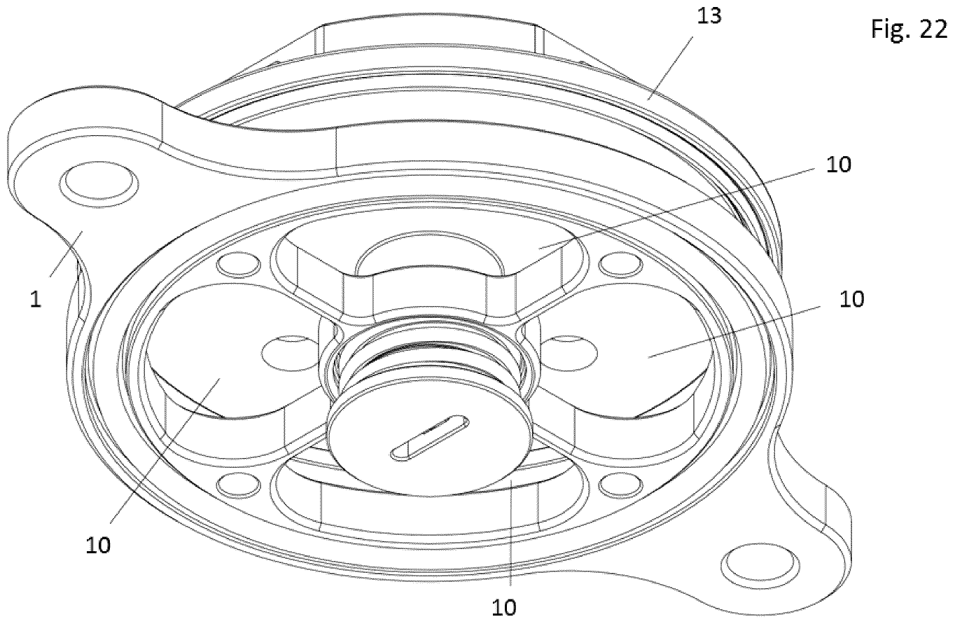

In the case of emergency venting, the cover 13 is lifted off the support 1 in the manner described in FIGS. 10 to 12, here FIGS. 22 to 24.

The overpressure acting inside the container acts directly on the holding part 19 of the cover 13 via the openings 10 of the support 1. The compression spring 27 surrounding the guide part 21 is set so that, in the case of emergency venting, the pressure of the gaseous medium inside the container is greater than the compressive force exerted by the compression spring 27. As a result, the cover 13 is lifted off the support 1 in the manner described, overcoming the force of the compression spring 27, thereby releasing the large opening cross-section 55 between the cover 13 and the support 1. The gaseous medium can thus pass very quickly through this large cross-section 55 into the environment outside the container. Preferably, the emergency venting is activated from an internal pressure in the container of more than 20 mbar, alternatively also at 40 mbar, in principle freely adjustable and suitable up to 500 mbar.

As soon as the excess pressure has been released, the cover 13 is pulled back against the support 1 by the compression spring 27, whereby the sealing ring 16 rests on the base body 4 of the support 1 with elastic deformation and prevents the passage between the cover 13 and the support 1.

As the medium does not flow through the double piston 58 in the event of emergency venting, a rapid and sudden reduction of the excess pressure inside the housing is ensured.

What is claimed is:

1. A pressure equalizing element for a container, comprising:
a housing (1, 13) having an inlet (26) and an outlet (17) for a gaseous medium; and
two valve elements (34, 37, 58), including,
a first valve element (34, 58) located in a flow path of the gaseous medium from the inlet (26) to the outlet (17);
a second valve element (37, 58) provided in the flow path of the gaseous medium from the inlet (26) to the outlet (17),
wherein the two valve elements (34, 37, 58) are pushed against each other with different forces, the forces being selected such that at least one of the two valve elements can be moved into a vacuum relief position and at least another of the two valve elements can be moved into an overpressure relief position.

2. The pressure equalizing element according to claim 1,
wherein the two valve elements (34, 37, 58) are each under a force of at least one compression spring (33, 39).

3. The pressure equalizing element according to claim 2,
wherein the two valve elements (34, 37, 58) are displaceably accommodated in a guide part (21).

4. The pressure equalizing element according to claim 3,
wherein the housing is formed by a cover (13) and a support (1).

5. The pressure equalizing element according to claim 4,
wherein the cover (13) is provided with the guide part (21).

6. The pressure equalizing element according to claim 4,
wherein the guide part (21) extends through the support (1).

7. The pressure equalizing element according to claim 4,
wherein the cover (13) is pulled against the support (1) by a tensile force.

8. The pressure equalizing element according to claim 7, further comprising
a further compression spring (27) for generating the tensile force,
wherein the further compression spring (27) is axially supported on the guide part (21) and on the support (1) on a side facing away from the cover (13).

9. The pressure equalizing element according to claim 4,
wherein the cover (13) lies sealingly against the support (1), and
wherein a sealing ring (16) is arranged between the cover (13) and the support (1).

10. The pressure equalizing element according to claim 1,
wherein the two valve elements (34, 37, 58) are arranged coaxially to each other.

11. The pressure equalizing element according to claim 2,
wherein the compression springs (33, 39) are coaxial to one another.

12. The pressure equalizing element according to claim 8,
wherein each compression spring (33, 39) and the further compression spring (27) are arranged coaxially to one another.

13. The pressure equalizing element according to claim 8,
wherein the further compression spring (27) surrounds the at least one compression spring (33, 39) for each of the two valve elements (34, 37) at a distance.

14. The pressure equalizing element according to claim 1,
wherein the two valve elements (34, 37) in the overpressure relief position have such an axial distance from each other that a passage for the gaseous medium from an interior of the container into an environment is created.

15. The pressure equalizing element according to claim 1,
wherein the first valve element is arranged adjacent to the container, and
wherein, in the vacuum relief position, the first valve element (34) is displaced against a stop (53) against a pressure force acting on it and allows access of the gaseous medium into the container from outside the container.

16. The pressure equalizing element according to claim 1,
wherein the two valve elements are formed by a one-piece double piston (58).

17. The pressure equalizing element according to claim 4,
wherein the support (1) has at least one passage (10) via which the pressure of the gaseous medium in the container acts on the cover (13) of the housing.

18. The pressure equalizing element according to claim 17,
wherein, when a predetermined pressure in the container is exceeded, the cover (13) lifts off the support (1) against a force of the further compression spring (27) and releases an outlet (55), the outlet (55) being determined by a distance between the support (1) and the cover (13).

19. The pressure equalizing element according to claim 1,
wherein a volume flow of the gaseous medium can be set separately for vacuum relief and overpressure relief via a geometry of the two valve elements (34, 37, 58).

20. The pressure equalizing element according to claim 1,
wherein the container is a battery housing of a vehicle, and
wherein the gaseous medium is air.
